(19) United States
(12) Patent Application Publication
(10) Pub. No.: US 2013/0052483 A1
(43) Pub. Date: Feb. 28, 2013

(54) Magnetoresistance Device

(71) Applicants: Taiebeh Tahmasebi, Singapore (SG); Seidikkurippu Nellainayagam Piramanayagam, Singapore (SG)

(72) Inventors: Taiebeh Tahmasebi, Singapore (SG); Seidikkurippu Nellainayagam Piramanayagam, Singapore (SG)

(73) Assignee: Agency for Science, Technology and Research

(21) Appl. No.: 13/599,319

(22) Filed: Aug. 30, 2012

Related U.S. Application Data
(60) Provisional application No. 61/529,278, filed on Aug. 31, 2011.

(51) Int. Cl. G11B 5/39

(52) U.S. Cl. 428/811.2

(57) ABSTRACT

A magnetoresistance device is provided. The magnetoresistance device includes a hard magnetic layer, and a soft magnetic layer having a multi-layer stack structure. The multi-layer stack structure has a first layer of a first material and a second layer of a second material. The first material includes cobalt iron boron and the second material includes a combination of a metallic element and any one of a group consisting of oxygen, nitrogen, carbon and fluorine.

This application claims the benefit of U.S. Provisional Application No. 61/529,278, filed Aug. 31, 2011.

### FIELD OF THE INVENTIONS

Various embodiments relate generally to a magnetoresistance device.

### BACKGROUND OF THE INVENTIONS

Giant magnetoresistive (GMR) spin valves (SV) generally include two ferromagnetic layers separated by a metallic spacer layer. The GMR-SVs exhibit large changes in resistance at different values of applied magnetic fields. Such characteristics of the GMR-SVs can allow the GMR-SVs to be applied in memory elements for magnetic random access memory (MRAM) as well as read head sensors for hard disk drives (HDD). For example, for digital recording in a memory device, a state with a high resistance can be considered as ‘1’ and a state with a low resistance can be considered as ‘0’. In order to distinguish the ‘0’ and ‘1’ states from the noise voltage, it is desirable that the GMR-SVs exhibit a high magnetoresistance. A larger magnetoresistance (MR) signal has been found in devices with a Magnetic Tunnel Junction (MTJ), where the magnetoresistance occurs due to the tunneling of electrons through an insulator layer between the ferromagnetic layers. The tunneling magnetoresistance (TMR) in MTJs is reported to be larger than GMR. Therefore, MTJ devices are considered for MRAM applications.

Magnetic random access memory (MRAM) is emerging as an alternative to conventional semiconductor memories. Compared to SRAM and DRAM, the MRAM has an advantage of non-volatility. Compared to flash memory used for storage of information, the MRAM has an advantage of endurance. In order to compete with flash memory, it is desirable to increase the density of the MRAM cells in a chip, which involves keeping the MRAM cells as small as possible. In order to compete with SRAM and DRAM, it is desirable to increase the speed of operation without compromising the density.

As compared to field-switchable MRAM devices, spin-torque transfer based MRAMs can be scalable to very small sizes (e.g. 5 nm of FePt material, based on the thermal stability considerations only). However, the smallest possible cell size is not only limited by thermal stability, but also by the writability. Devices with FePt may require a large write current required for the write operation. Moreover, two geometries, one with magnetization in plane and another with magnetization out-of-plane (perpendicular), are being investigated.

For forming MRAM with a perpendicular geometry, materials with a high perpendicular anisotropy such as Co/Pd multilayers and ordered L1₀-FePt have been considered. While these materials may be suitable for the hard layers of the MRAM devices (that retain their magnetization direction), their use as the soft layer is difficult. Devices based on Co/Pd multilayers or FePt layers have a high anisotropy constant and hence they can retain their magnetization in a stable manner. However, as the writing current is also proportional to the anisotropy constant, such materials need a high current to switch, posing a limitation in the transistor size (or the density of cells) or in the operating speed.

FIG. 1a shows a schematic diagram of a conventional magnetoresistance device 100 having a magnetic tunnel junction device structure. The conventional magnetoresistance device 100 uses cobalt iron boron (CoFeB) as a soft magnetic layer 102. The soft magnetic layer 102 may have a thickness greater than 1 nm. It can be observed from graph 120 shown in FIG. 1b that a CoFeB soft magnetic layer 102 having a thickness of about 1.3 nm exhibits perpendicular magnetic anisotropy. It can also be observed from graph 140 that a CoFeB soft magnetic layer 102 having a thickness of about 2.0 nm exhibits in-plane anisotropy. The conventional magnetoresistance device 100 may have a tunneling magnetoresistance (TMR) signal of above 100%. Moreover, a high value of an anisotropy constant (around 2×10⁶ erg/cc) indicates that the thin layer of CoFeB with perpendicular magnetic anisotropy may also be suitable for devices with a diameter of about 40 nm. FIG. 1d shows that the device size of the conventional magnetoresistance device 100 can be reduced to 40 nm while maintaining thermally stability.

### SUMMARY

According to one embodiment, a magnetoresistance device is provided. The magnetoresistance device includes a hard magnetic layer, and a soft magnetic layer having a multi-layer stack structure. The multi-layer stack structure has a first layer of a first material and a second layer of a second material. The first material includes cobalt iron boron. The second material includes a combination of a metallic element and any one of a group consisting of oxygen, nitrogen, carbon and fluorine.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1a shows a schematic diagram of a conventional magnetoresistance device.

FIG. 1b and 1c show graphs illustrating perpendicular magnetic anisotropy and in-plane anisotropy of a soft magnetic layer of a conventional magnetoresistance device.

FIG. 1d shows a picture of a conventional magnetoresistance device.

FIG. 2 shows a three-dimensional view of a magnetoresistance device according to one embodiment.

FIG. 3 shows a schematic diagram of a multi-layer stack structure of a soft magnetic layer of a magnetoresistance device according to one embodiment.

FIG. 4 shows a three-dimensional view of a magnetoresistance device according to one embodiment.

FIG. 5 shows a graph illustrating a hysteresis loop of a conventional magnetoresistance device.

FIGS. 6a to 6c shows graphs illustrating a hysteresis loop of a magnetoresistance device having a CoFeB/TaN multi-layer stack structure as a soft magnetic layer according to one embodiment.

### DETAILED DESCRIPTION OF THE INVENTIONS

Embodiments of a magnetoresistance device will be described in detail below with reference to the accompanying figures. It will be appreciated that the embodiments described below can be modified in various aspects without changing the essence of the invention.

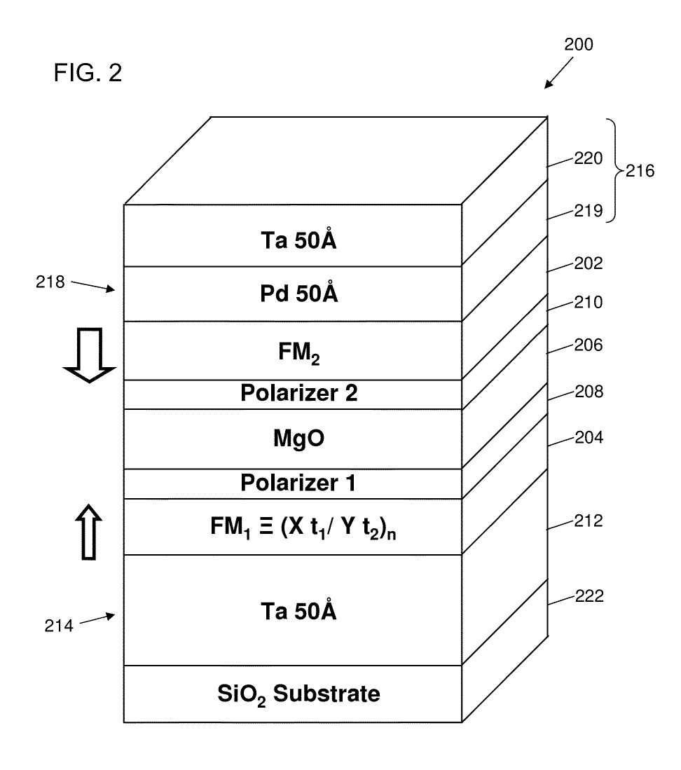

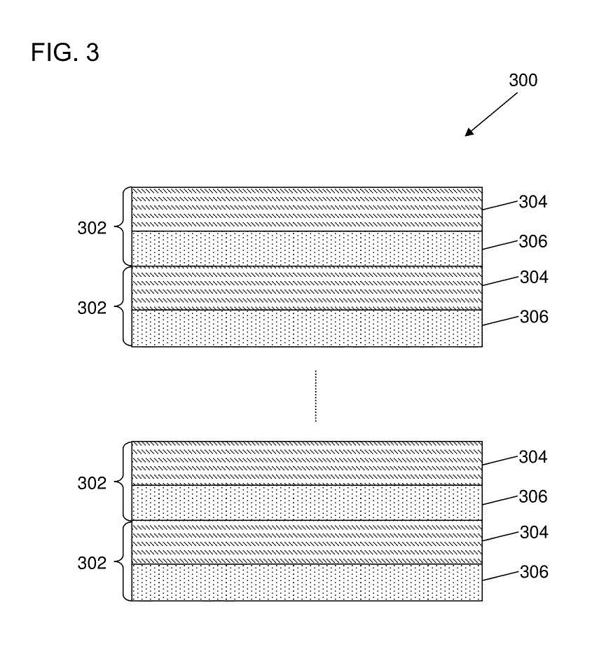

FIG. 2 shows a three-dimensional view of a magnetoresistance device 200 according to one embodiment. The magnetoresistance device 200 has a hard magnetic layer 202 and a soft magnetic layer 204. In one embodiment, the soft magnetic layer 204 has a multi-layer stack structure 300 as shown in FIG. 3. The multi-layer stack structure 300 has one or more stacks 302. The number of stacks 302 of the multi-layer stack structure 300 ranges from 1 to 20. The number of stacks 302 may affect the stability of the soft magnetic layer 204. When the number of stacks 302 is larger, the soft magnetic layer 204 is thicker and is more stable.

Each stack 302 has a first layer 304 of the first material and a second layer 306 of the second material. The multi-layer stack structure 300 may have an alternating arrangement of the first layer 304 of the first material and the second layer 306 of the second material.

In one embodiment, the first material may be a magnetic material or a ferromagnetic material. The first material may include cobalt iron boron (CoFeB).

The second material may be a non-magnetic material. The second material may include a combination of a metallic element and any one of a group consisting of oxygen, nitrogen, carbon and flourine. The metallic element may include but is not limited to tantalum, titanium, ruthenium, rhodium, palladium, platinum, tungsten, zirconium and terbium. Thus, the second material may include but is not limited to tantalum nitride, titanium nitride, ruthenium oxide, rhodium oxide, palladium nitride, platinum nitride, tungsten nitride, zirconium nitride and terbium nitride. In one embodiment, the second material may include a combination of a metallic element and any one of elements in any group of a periodic table of elements (e.g. Group 16 consisting of oxygen, Group 15 consisting of nitrogen, Group 14 consisting of carbon and Group 17 consisting of fluorine).

A thin layer of cobalt iron boron with perpendicular magnetic anisotropy (PMA) showed high anisotropy. Thus, using cobalt iron boron in the soft magnetic layer 204 can make the perpendicular magnetic anisotropy (PMA) in the soft magnetic layer 204 to be stronger. Therefore, the soft magnetic layer 204 may be more stable. As such, it may be possible to reduce the size of the magnetoresistance device 200 to e.g. below 40 nm. The magnetoresistance device 200 having a reduced size may be used for higher storage density.

A value of magnetization for the first layer 304 of the first material (e.g. the first layer 304 of cobalt iron boron) may be chosen to reduce a switching current and to improve the perpendicular magnetic anisotropy (PMA). The perpendicular magnetic anisotropy (PMA) of the soft magnetic layer 204 may be controlled for suitable thermal stability by using the thickness of the second layer 306 of the second material or by using seed layers.

The first layer 304 of cobalt iron boron may have optimized concentration of cobalt and iron. In one embodiment, the CoFeB composition may be Co₂₀Fe₆₀B₂₀. The switching current can be optimized by varying the composition of CoₓFe_{1-x-y}B_{y} or Co₈₀₋ₓFeₓB₂₀, Co₆₀Fe₂₀B₂₀ or Co₄₀Fe₄₀B₂₀.

In one embodiment, the first layer 304 of the first material and the second layer 306 of the second material may have the same thickness. In another embodiment, the first layer 304 of the first material and the second layer 306 of the second material may have different thicknesses. The first layer 304 of the first material may have a thickness ranging from about 0.25 nm to about 1.5 nm. The second layer 306 of the second material may have a thickness ranging from about 0.25 nm to about 1 nm.

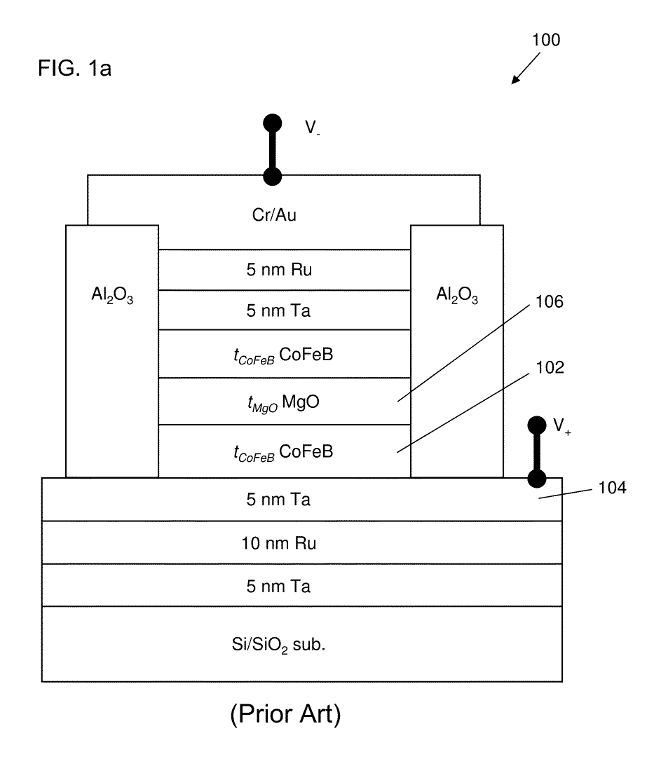

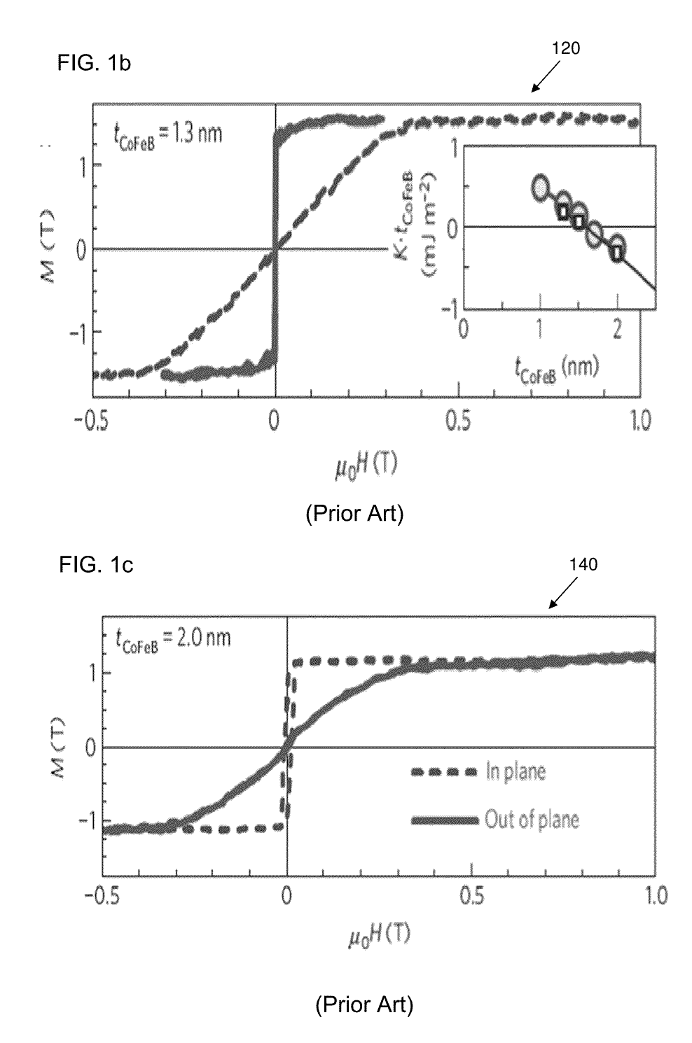

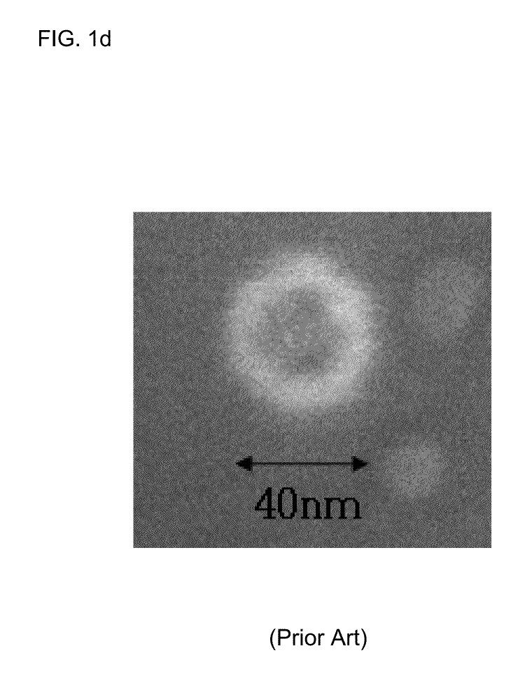

Referring back to FIG. 1, the hard magnetic layer 202 may include any hard layer with perpendicular magnetic anisotropy (PMA). The hard magnetic layer 202 may include but is not limited to cobalt platinum (e.g. L1₀ CoPt) and iron platinum (e.g. L1₀ FePt). The hard magnetic layer 202 may also include a multi-layer stack structure. The multi-layer stack structure of the hard magnetic layer 202 may be similar to the multi-layer stack structure 300 of the soft magnetic layer 204. The multi-layer stack structure of the hard magnetic layer 202 may have a first layer of cobalt and a second layer of material. The first layer of cobalt and a second layer of material may be arranged in an alternating arrangement. The material used for the second layer may include but is not limited to platinum, palladium, iron palladium and nickel. The material used for the second layer may also include a combination of materials including but not limited to platinum, palladium, iron palladium and nickel.

In one embodiment, the multi-layer stack structure of the hard magnetic layer 302 may have ten stacks. Each stack may have a first layer of cobalt and a second layer of palladium. Each first layer of cobalt may have a thickness ranging from about 0.1 nm to about 1.2 nm. Each second layer of palladium may have a thickness ranging from about 0.3 nm to about 1.5 nm.

The magnetoresistance device 200 may also include a spacer layer 206 disposed between the hard magnetic layer 202 and the soft magnetic layer 204. In one embodiment, the spacer layer 206 may include materials for achieving higher tunneling magnetoresistance (TMR). The spacer layer 206 may include magnesium oxide (MgO). In another embodiment, the spacer layer 206 may include a combination of magnesium and magnesium oxide or aluminum oxide (AlₓO_{y}). In another embodiment, the spacer layer 206 may include copper or titanium oxide (TiOₓ). The spacer layer 206 may have a thickness ranging from about 0.8 nm to about 2 nm.

The magnetoresistance device 200 may further include a first spin-polarizing layer 208 and a second spin-polarizing layer 210. The first spin-polarizing layer 208 is disposed between the spacer layer 206 and the soft magnetic layer 204. The second spin-polarizing layer 210 is disposed between the spacer layer 206 and the hard magnetic layer 202.

The first spin-polarizing layer 208 may include but is not limited to cobalt, iron, nickel, cobalt based alloy, iron based alloy and nickel based alloy. The second spin-polarizing layer 210 may include but is not limited to cobalt, iron, nickel, cobalt based alloy, iron based alloy and nickel based alloy.

In one embodiment, the cobalt based alloy may have a formula Co—X. The iron based alloy may have a formula Fe—X. The nickel based alloy may have a formula Ni—X. X may include but is not limited to boron, oxygen, zirconium and terbium.

In one embodiment, the cobalt based alloy may have a formula Co—XY. The iron based alloy may have a formula Fe—XY. The nickel based alloy may have a formula Ni—XY. X may include but is not limited to cobalt, iron and nickel. Y may include but is not limited to boron, oxygen, zirconium and terbium.

The first spin-polarizing layer 208 may have a thickness ranging from about 5 Å to about 20 Å. The second spin-polarizing layer 210 may have a thickness ranging from about 5 Å to about 20 Å.

The first spin-polarizing layer 208 and the second spin-polarizing layer 210 may be disposed adjacent to the spacer layer 206 to increase an interface quality at the tunnel barrier and to enhance the spin polarization in order to improve the tunneling for achieving a higher tunneling magnetoresistance (TMR) signal. The thicknesses of the first spin-polarizing layer 208 and the second spin-polarizing layer 210 may be varied to increase the magnetoresistance value. A larger thickness for the first spin-polarizing layer 208 and the second spin-polarizing layer 210 is desirable to prevent the transfer of fcc (111) texture from the soft magnetic layer 204 to the spacer layer 206 or from the seed layer (details of which will be described later) to the spacer layer 206 as the spacer layer 206 exhibits desired properties in the body centered (bcc) (200) texture.

The magnetoresistance device 200 may include a seed layer structure 212. The seed layer structure 212 may be arranged such that the soft magnetic layer 204 is disposed between the seed layer structure 212 and the first spin-polarizing layer 208. The seed layer structure 212 may include at least one layer. The at least one layer of the seed layer structure 212 may include a material or a combination of materials selected from a group of materials consisting of tantalum, chromium, titanium, nickel, tungsten, ruthenium, palladium, platinum, zirconium, hafnium, silver, gold, aluminum, antimony, molybdenum, tellurium, cobalt iron, cobalt iron boron and cobalt chromium. The at least one layer of the seed layer structure 212 may have a thickness ranging from about 0 nm to about 7 nm. In other words, the seed layer structure 212 may have a thickness ranging from about 0 nm to about 7 nm.

In one embodiment, the seed layer structure 212 may function as an electrode 214. When the seed layer structure 212 is used as the electrode 214, the seed layer structure 212 may have a thickness greater than 7 nm.

In one embodiment, the seed layer structure 212 may include tantalum, ruthenium, titanium, chromium ruthenium or zirconium. The thickness of the seed layer structure 212 may vary from about 1 nm to about 10 nm.

The seed layer structure 212 may enhance perpendicular magnetic anisotropy. A seed layer structure 212 with a smaller thickness is desirable for having a more coherent tunneling through the spacer layer 206. Perpendicular magnetic anisotropy (PMA) may be achieved in the soft magnetic layer 204 with a minimum thickness of about 10 Å for the seed layer structure 212.

The magnetoresistance device 200 may further include a capping layer structure 216. The capping layer structure 216 may be arranged such that the hard magnetic layer 202 is disposed between the capping layer structure 216 and the second spin-polarizing layer 210. The capping layer structure 216 may be used as an electrode 218.

The capping layer structure 216 may include at least one layer. The at least one layer of the capping layer structure 216 may include a material or a combination of materials selected from a group of materials consisting of tantalum, chromium, titanium, nickel, tungsten, ruthenium, palladium, platinum, zirconium, hafnium, silver, gold, aluminum, antimony, molybdenum, tellurium and cobalt chromium. In one embodiment, the capping layer structure 116 may have a thickness ranging from about 30 Å to about 100 Å.

The number of layers of the capping layer structure 216 can vary for different embodiments. In one embodiment (e.g. as illustrated in FIG. 2), the capping layer structure 216 may include a first layer 219 and a second layer 220. The first layer 219 may be disposed between the hard magnetic layer 202 and the second layer 220. The first layer 219 may include palladium. The second layer 220 may include tantalum or ruthenium. The second layer 220 can be used to avoid oxidation. The first layer 219 may have a thickness ranging from about 30 Å to about 70 Å. The second layer 220 may have a thickness ranging from about 30 Å to about 70 Å.

In another embodiment, the capping layer structure 216 may include only one layer 220. The second layer 220 may include tantalum or ruthenium. The layer 220 may have a thickness ranging from about 30 Å to about 100 Å.

The magnetoresistance device 200 may also include a substrate 222. The substrate 222 may be disposed adjacent the seedlayer structure 212. The substrate 222 may be arranged such that the seedlayer structure 212 is disposed between the substrate 222 and the soft magnetic layer 204. In one embodiment, the substrate 222 includes but is not limited to silicon dioxide, silicon, silicon nitride, magnesium oxide and glass.

In one embodiment, the magnetoresistance device 200 has the hard magnetic layer 202 arranged above the spacer layer 206 and the soft magnetic layer 204 arranged below the spacer layer 206.

In another embodiment, the magnetoresistance device 200 may have the hard magnetic layer 202 arranged below the spacer layer 206 and the soft magnetic layer 204 arranged above the spacer layer 206.

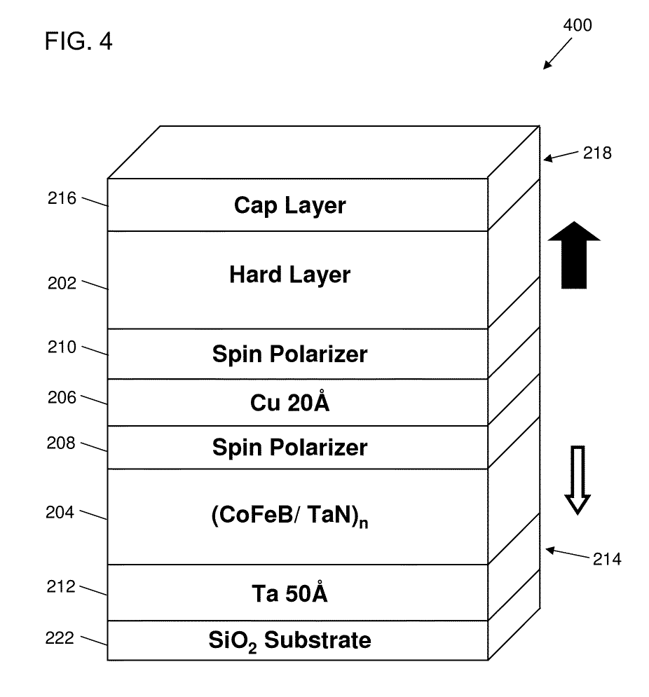

FIG. 4 shows a three-dimenional view of a magnetoresistance device 400 according to one embodiment. The magnetoresistance device 400 is similar to the magnetoresistance device 100. The soft magnetic layer 204 of the magnetoresistance device 400 includes cobalt iron boron (CoFeB) for the first material and tantalum nitride (TaN) for the second material. The spacer layer 206 of the magnetoresistance device 400 includes copper. The spacer layer 206 may have a thickness of about 20 Å.

The magnetoresistance devices described above can have a low switching current that can be used in spin-transfer torque magnetic random access memory (STT-MRAM). In MRAM applications, the magnetoresistance devices may be part of a memory circuit, along with transistors that provide the read and write currents. The magnetoresistance devices can work as or can be part of a multi-level MRAM. The magnetoresistance devices can also be applicable to read-sensors of hard disk drives and magnetic field sensors.

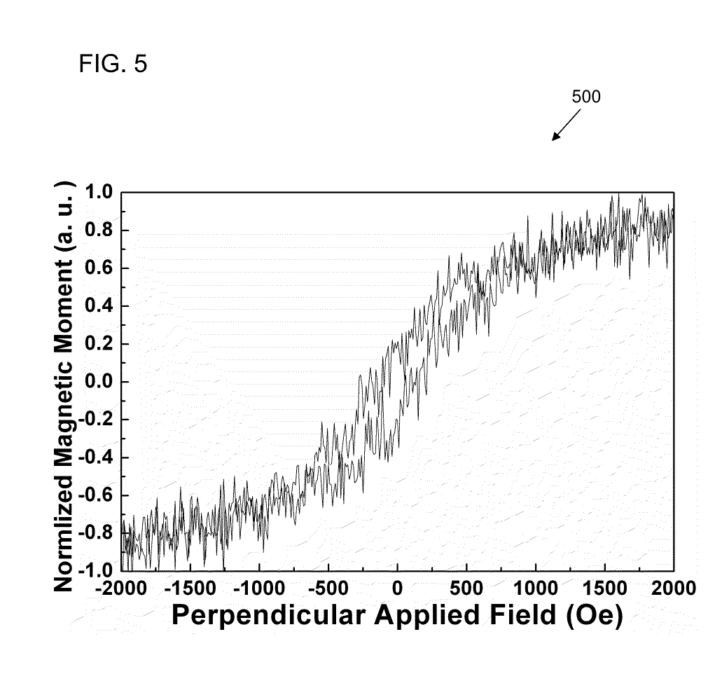

FIG. 5 shows a graph 500 illustrating a hysteresis loop of a conventional magnetoresistance device having a CoFeB/Ta multi-layer structure as a soft magnetic layer. Tantalum (Ta) is used as the second material for the second layer in the multi-layer structure of the soft magnetic layer. Graph 500 shows normalized magnetic moment plotted against perpendicular applied field. It can be observed from graph 500 that there is no perpendicular magnetic anisotropy. Graph 500 only shows an in-plane magnetic anisotropy.

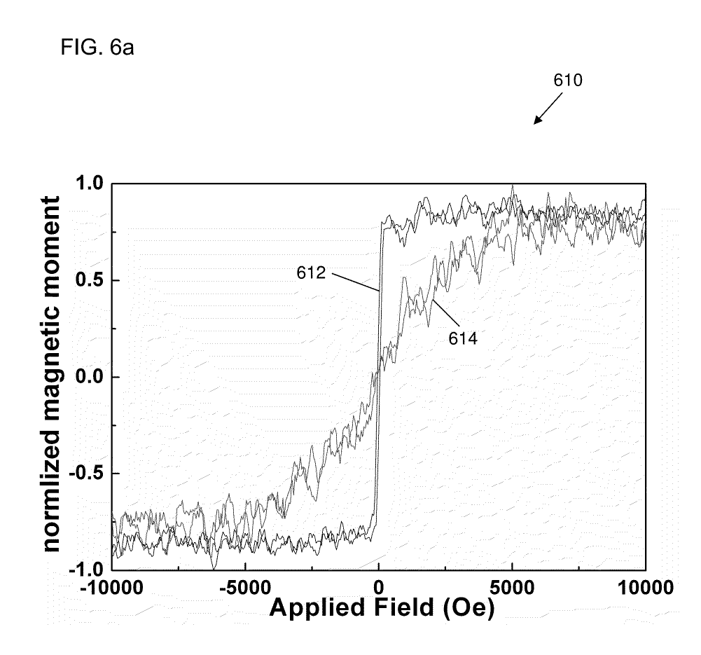

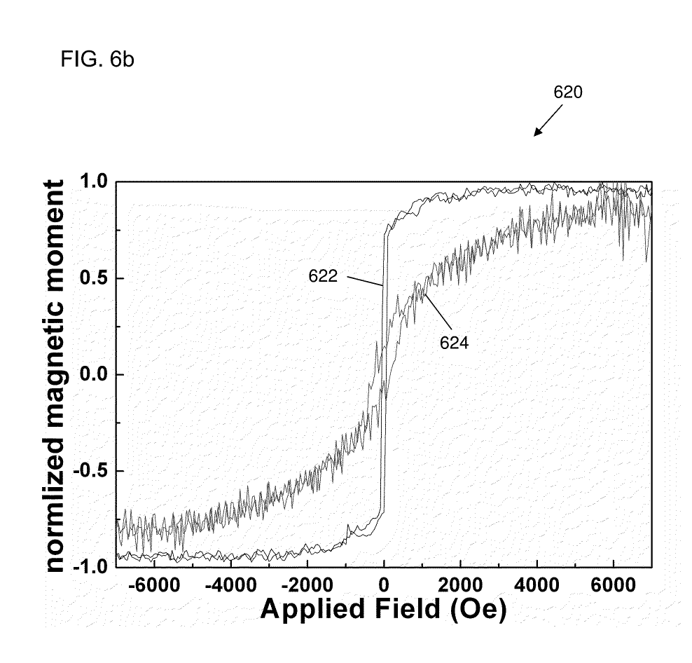

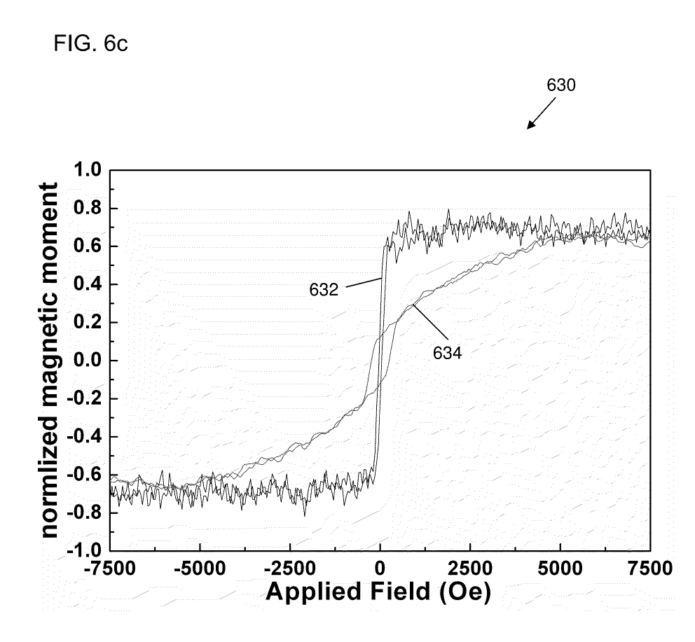

FIGS. 6a to 6c shows graphs illustrating a hysteresis loop of a magnetoresistance device 200 having a CoFeB/TaN multi-layer stack structure 300 as a soft magnetic layer 204. In one embodiment, the spacer layer 206 may include magnesium oxide and may have a thickness of about 20 Å. The first spin-polarizing layer 208 may include CoFeB and may have a thickness of about 10 Å. The seed layer structure 212 may include tantalum and may have a thickness of about 50 Å.

For FIG. 6a, the CoFeB/TaN multi-layer stack structure 300 has one stack 302 of a first layer 304 of CoFeB and a second layer 306 of TaN (i.e. one bilayer of CoFeB/TaN). The first layer 304 of CoFeB may have a thickness of 10 Å. FIG. 6a shows a graph 610 of normalized magnetic moment plotted against perpendicular applied field. Plot 612 shows the perpendicular magnetic anisotropy of the magnetoresistance device 200. Plot 614 shows the in-plane magnetic anisotropy of the magnetoresistance device 200.

For FIG. 6b, the CoFeB/TaN multi-layer stack structure 300 has two stacks 302 of a first layer 304 of CoFeB and a second layer 306 of TaN (i.e. two bilayers of CoFeB/TaN). The first layer 304 of CoFeB may have a thickness of 10 Å. FIG. 6b shows a graph 620 of normalized magnetic moment plotted against perpendicular applied field. Plot 622 shows the perpendicular magnetic anisotropy of the magnetoresistance device 200. Plot 624 shows the in-plane magnetic anisotropy of the magnetoresistance device 200.

For FIG. 6c, the CoFeB/TaN multi-layer stack structure 300 has three stacks 302 of a first layer 304 of CoFeB and a second layer 306 of TaN (i.e. three bilayers of CoFeB/TaN). The first layer 304 of CoFeB may have a thickness of 10 Å. The total thickness of the CoFeB material may be about 4 nm. FIG. 6c shows a graph 630 of normalized magnetic moment plotted against perpendicular applied field. Plot 632 shows the perpendicular magnetic anisotropy of the magnetoresistance device 200. Plot 634 shows the in-plane magnetic anisotropy of the magnetoresistance device 200.

It can be observed from graphs 610, 620 and 630 that perpendicular magnetic anisotropy can be obtained using CoFeB/TaN multi-layers as the soft magnetic layer 204. Therefore, a suitable material has to be chosen for the second layer 306 of the multi-layer stack structure 300 for obtaining perpendicular magnetic anisotropy in a thick CoFeB layer.

Looking at the results of graph 140 of FIG. 1c, thick CoFeB layers may not exhibit perpendicular magnetic anisotropy. However, the magnetoresistance device as described above can provide thick CoFeB layers with a perpendicular magnetic anisotropy. In other words, the thickness of CoFeB layers can be increased without sacrificing the perpendicular magnetic anisotropy. This can be provided by choosing a suitable material for the second layer 306 of the multi-layer stack structure 300 of the soft magnetic layer 204.

By having thick CoFeB layers with perpendicular magnetic anisotropy, the diameter of the magnetoresistance device can be reduced. Thermal stability can be achieved in small device diameter, and thus enabling higher density (or capacity) memory. Optimized values of switching current and switching speed can also be obtained.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A magnetoresistance device, comprising:
a hard magnetic layer;
a soft magnetic layer comprising a multi-layer stack structure;
wherein the multi-layer stack structure has a first layer of a first material and a second layer of a second material;
wherein the first material comprises cobalt iron boron;
wherein the second material comprises a combination of a metallic element and any one of a group consisting of oxygen, nitrogen, carbon and fluorine.

2. The magnetoresistance device of claim 1, wherein the second material comprises any one of tantalum nitride, titanium nitride, ruthenium oxide, rhodium oxide, palladium nitride, platinum nitride, tungsten nitride, zirconium nitride and terbium nitride.

3. The magnetoresistance device of claim 1,
wherein the multi-layer stack structure comprises one or more stacks;
wherein each stack has a first layer of the first material and a second layer of the second material.

4. The magnetoresistance device of claim 3, wherein the number of stacks of the multi-layer stack structure ranges between 1 to 20.

5. The magnetoresistance device of claim 1, wherein the hard magnetic layer comprises any one of a group consisting of cobalt platinum, iron platinum, and a multi-layer stack structure having a first layer of cobalt, iron or cobalt iron and a second layer of material comprising a material or a combination of materials selected from a group of materials consisting of platinum, palladium, iron palladium, iron platinum and nickel.

6. The magnetoresistance device of claim 1, further comprising a spacer layer disposed between the hard magnetic layer and the soft magnetic layer.

7. The magnetoresistance device of claim 6, wherein the spacer layer comprises any one of a group consisting of magnesium oxide, combination of magnesium and magnesium oxide, copper and aluminum oxide (AlₓO_{y}).

8. The magnetoresistance device of claim 6, further comprising:
a first spin-polarizing layer disposed between the spacer layer and the soft magnetic layer; and
a second spin-polarizing layer disposed between the spacer layer and the hard magnetic layer.

9. The magnetoresistance device of claim 8, wherein the first spin-polarizing layer and the second spin-polarizing layer comprise any one of a group consisting of cobalt, iron, nickel, cobalt based alloy, iron based alloy and nickel based alloy.

10. The magnetoresistance device of claim 9,
wherein the cobalt based alloy has a formula Co—X, the iron based alloy has a formula Fe—X, and the nickel based alloy has a formula Ni—X;
wherein X comprises any one of a group consisting of boron, oxygen, terbium and zirconium.

11. The magnetoresistance device of claim 9,
wherein the cobalt based alloy has a formula Co—XY, the iron based alloy has a formula Fe—XY, and the nickel based alloy has a formula Ni—XY;
wherein X comprises any one of a group consisting of cobalt, iron and nickel and Y comprises any one of a group consisting of boron, oxygen, zirconium and terbium.

12. The magnetoresistance device of claim 8,
further comprising a seed layer structure;
wherein the soft magnetic layer is between the seed layer structure and the first spin-polarizing layer.

13. The magnetoresistance device of claim 12, wherein the seed layer structure functions as an electrode.

14. The magnetoresistance device of claim 12,
wherein the seed layer structure comprises at least one layer;
wherein the at least one layer of the seed layer structure comprises a material or a combination of materials selected from a group of materials consisting of tantalum, chromium, titanium, nickel, tungsten, ruthenium, palladium, platinum, zirconium, hafnium, silver, gold, aluminum, antimony, molybdenum, tellurium, nickel chromium, tantalum nitride, titanium nitride and cobalt chromium.

15. The magnetoresistance device of claim 8,
further comprising a capping layer structure;
wherein the hard magnetic layer is between the capping layer structure and the second spin-polarizing layer.

16. The magnetoresistance device of claim 15, wherein the capping layer structure is used as an electrode.

17. The magnetoresistance device of claim 15,
wherein the capping layer structure comprises at least one layer;
wherein the at least one layer of the capping layer structure comprises a material or a combination of materials selected from a group of materials consisting of tantalum, chromium, titanium, nickel, tungsten, ruthenium, palladium, platinum, zirconium, hafnium, silver, gold, aluminum, antimony, molybdenum, tellurium and cobalt chromium.
